(19) United States
(12) Patent Application Publication
(10) Pub. No.: US 2019/0381666 A1
(43) Pub. Date: Dec. 19, 2019

(54) SAFETY CONTROL SYSTEM FOR AN INDUSTRIAL ROBOT AND THE INDUSTRIAL ROBOT

(71) Applicant: Siemens Aktiengesellschaft, Muenchen (DE)

(72) Inventors: George Lo, Langhorne, PA (US); Jian Qiang WU, Shanghai (CN); Xing YI, Shanghai (CN); Yue ZHUO, Beijing (CN)

(73) Assignee: Siemens Aktiengesellschaft, Muenchen (DE)

(21) Appl. No.: 16/435,731

(22) Filed: Jun. 10, 2019

(30) Foreign Application Priority Data
Jun. 14, 2018 (CN) 201820926737.X

(51) Int. Cl. B25J 9/16

(52) U.S. Cl. CPC B25J 9/1674; G05B 2219/50391; G05B 2219/50193

(57) ABSTRACT

The present application provides a safety control system for an industrial robot and an industrial robot including the safety control system. In an embodiment, the safety control system includes a first safety controller connected to at least one core safety sensor outputting a core safety signal, to receive the core safety signal; and a second safety controller connected to at least one safety-related sensor outputting a safety-related signal, to receive the safety-related signal. In an embodiment, the first safety controller and the second safety controller are respectively connected to a safety actuating system.

### PRIORITY STATEMENT

The present application hereby claims priority under 35 U.S.C. § 119 to Chinese patent application number CN 201820926737.X filed Jun. 14, 2018, the entire contents of which are hereby incorporated herein by reference.

### FIELD

Embodiments of the invention generally relate to a safety control system for an industrial robot and an industrial robot equipped with the safety control system.

### BACKGROUND

A robot system, for example, an industrial robot system, usually comprises a control unit and robot units performing various operations under the control of the control unit. Robot units can include actuators such as robot manipulator performing operations, drivers used to drive robot manipulators, and a power supply used to supply power. The control unit can generate control commands used to control robot units.

To protect the safety of other equipment and personnel working in the environment of an industrial robot system, specific safety functions are required of the industrial robot system. For example, detailed provisions on the safety functions required for industrial robots and the reliability of safety functions are made in the international standard ISO 10218-1 and the Chinese national standard GB 11291.1.

### SUMMARY

The inventors have discovered problems with previous solutions of known systems used to meet the safety requirements. To meet the safety requirements, two solutions were usually adopted for the industrial robot systems in known systems. One solution was that the robot systems were equipped with a system controller fulfilling the functional safety to satisfy all functions required for safety so as to provide reliable safety control for operators. However, the inventors of this application discovered that such a solution will increase the cost of the robot systems. Another solution was that the robot systems were equipped with a specific logic circuit to reduce the cost. However, the inventors of this application discovered that because of the limited operational capability of such an application specific integrated circuit (ASIC), the solution can provide only basic safety functions and is difficult to apply to different industrial robot systems.

At least one embodiment of the present application provides a safety control system for an industrial robot, wherein the safety control system comprises a first safety controller, which is connected to at least one core safety sensor outputting a core safety signal and receives the core safety signal, and a second safety controller, which is connected to at least one safety-related sensor outputting a safety-related signal and receives the safety-related signal, wherein the first safety controller and the second safety controller are respectively connected to a safety actuating system.

At least one embodiment of the present application provides a safety control system for an industrial robot, comprising:
a first safety controller, connected to at least one core safety sensor configured to output a core safety signal, to receive the core safety signal when output; and
a second safety controller, connected to at least one safety-related sensor configured to output a safety-related signal, to receive the safety-related signal, wherein the first safety controller and the second safety controller are respectively connected to a safety actuating system.

Another embodiment of the present application provides a robot system, wherein the robot system comprises the safety control system described in any of the embodiments.

### BRIEF DESCRIPTION OF THE DRAWING

The following drawing only aims at giving an illustrative description and explanation of the present application, but not limiting the scope of the present application. In the drawing,

FIG. 1 is a schematic diagram for the safety control system for an industrial robot according to an embodiment.

### DETAILED DESCRIPTION OF THE EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated. The present invention, however, may be embodied in many alternate forms and should not be construed as limited to only the example embodiments set forth herein.

To let those skilled in the art better understand the technical solution of the present invention, the following will clearly and completely describe the technical solution in the embodiments of the present invention in combination with the drawings in the embodiments of the present invention. Obviously, the embodiments described are only a part, but not all of the embodiments of the present invention. All other embodiments obtained by those skilled in the art on the basis of the embodiments of the present invention without any creative work should fall within the scope of protection of the present invention.

It should be noted that the terms “first” and “second” in the description, claims and the drawings are used to distinguish between similar objects, but not necessarily used to describe a specific order or sequence. These terms are only used to distinguish one element from another. It should be understood that the data used in such a way can be interchanged as appropriate so that the described embodiments of the present invention can be implemented in an order other than that shown or described here. As used herein, the term “and/or,” includes any and all combinations of one or more of the associated listed items. The phrase “at least one of” has the same meaning as “and/or”. In addition, the terms “comprise” and “have” and their variants are intended to cover non-exclusive inclusions. For example, the process or method comprising a series of steps or the system, product or equipment comprising a series of modules or units are unnecessarily limited to those clearly-listed steps or modules or units, but can comprise other steps or modules or units which are not clearly listed or are intrinsic to the process, method, product or equipment.

Spatially relative terms, such as “beneath,” “below,” “lower,” “under,” “above,” “upper,” and the like, may be used herein for ease of description to describe one element or feature's relationship to another element(s) or feature(s) as illustrated in the FIGURES. It will be understood that the spatially relative terms are intended to encompass different orientations of the device in use or operation in addition to the orientation depicted in the FIGURES. For example, if the device in the FIGURES is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

It should also be noted that in some alternative implementations, the functions/acts noted may occur out of the order noted in the FIGURES. For example, two FIGURES shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Before discussing example embodiments in more detail, it is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the FIGURE. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

Units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one embodiment of the invention relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Most of the aforementioned components, in particular the identification unit, can be implemented in full or in part in the form of software modules in a processor of a suitable control device or of a processing system. An implementation largely in software has the advantage that even control devices and/or processing systems already in use can be easily upgraded by a software update in order to work in the manner according to at least one embodiment of the invention.

At least one embodiment of the present application provides a safety control system for an industrial robot, wherein the safety control system comprises a first safety controller, which is connected to at least one core safety sensor outputting a core safety signal and receives the core safety signal, and a second safety controller, which is connected to at least one safety-related sensor outputting a safety-related signal and receives the safety-related signal, wherein the first safety controller and the second safety controller are respectively connected to a safety actuating system.

According to at least one embodiment of the present application, the first safety controller is usually a main controller and can meet the safety standard for PL=d, category III in ISO13849-1 or SIL2 in IEC62061, and the second safety controller is an auxiliary controller. Through such a design, the cost of realizing the safety functions is lower than that of an automatic malfunction controller. This solution can provide redundant functions and can be flexibly applied to different types of industrial robot control systems. In addition, this solution can lower the cost of a robot system in safety licensing.

According to at least one embodiment of the present application, the core safety sensor and safety-related sensor are both customized by the user according to their working environments or the working environment and condition of the robot. Accordingly, core safety signals and safety-related signals are also customized. The signals of the safety-related sensor can be, for example, the braking state of a brake, error reporting monitoring signal of servo driver, ZSP monitoring signal, and key switch of the demonstrator. The core safety sensor can usually include, for example, the enable switch of the demonstrator, emergency stop button inside or outside the demonstrator or safety cage, and door switch of the safety cage. In the present application, a signal refers to information in any form and/or an input/output into/from a controller. The sensor in the present application refers to any equipment that can sense actions or changes, and it can be, for example, a sensor or sensor element in a narrow sense, such as photosensor, infrared sensor, position sensor, and speed sensor, and it can also be a switch component or a component which can sense a door switch.

According to a preferable embodiment, the first safety controller is a safety relay. The safety relay is a programmable device and can be applied to different industrial robots by changing the program. The safety controller has passed a plurality of safety authentications, and no safety authentication is additionally required for the safety controller here.

According to a preferable embodiment, each of the core safety sensors comprises two identical sensor elements and is connected to the first safety controller through two channels. Such a design realizes redundant control specially for the functions related to the safety core.

According to a preferable embodiment, the first safety controller is connected to at least one the safety-related sensor and receives the safety-related signal. In this way, the first safety controller can also make a determination on the safety-related signal, and will take the corresponding control action when the safety-related signal is considered as a core safety signal.

According to a preferable embodiment, the first safety controller communicates with the second safety controller. Hence, the first safety controller and the second safety controller can mutually transmit information and signals for cross checks.

According to a preferable embodiment, the safety actuating system comprises a first safety actuating device, wherein the first safety controller and the second safety controller are respectively connected to the first safety actuating device for communication.

According to a preferable embodiment, the safety actuating system comprises a second safety actuating device and/or a third safety actuating device, wherein the first safety controller is connected to the second safety actuating device and/or the third safety actuating device for communication.

According to the customization of at least one embodiment, the first safety controller can be connected to the actuators performing core safety actuations to control the actuators. When these actuators additionally provide moderate actuations, they can be controlled by the second safety controller. In this way, the wear-out caused by a core safety actuation, for example, emergency stop, can be reduced.

According to a preferable embodiment, the second safety controller is a part of a robot controller. Thus, the robot controller can effectively be utilized to realize redundant safety control.

Another embodiment of the present application provides a robot system, wherein the robot system comprises the safety control system described in any of the embodiments.

To understand more clearly the technical characteristics, objects, and effects of the present application, the following describes the embodiments of the present application in combination with the drawing.

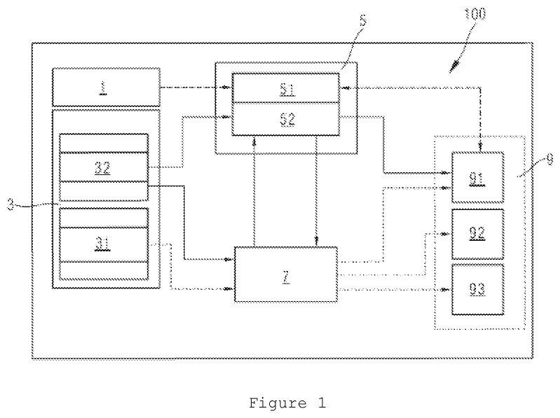

FIG. 1 is a schematic diagram for the safety control system for an industrial robot according to an embodiment of the present application. To realize safety control, the safety control system 100 comprises a main safety controller 7 and an auxiliary safety controller 52. Wherein the main safety controller 7 is a technically mature safety controller or safety relay and at least meets the safety standard for PL=d, category III in ISO13849-1 or SIL2 in IEC62061. The auxiliary safety controller 52 can be a part of a robot controller 5, and the robot controller 5 can comprise a robot control unit 51 controlling a robot, and an auxiliary safety controller 52.

In an industrial robot system, the user can classify the signals generated by the equipment in the robot system into the following types of signals relative to the safety control system 100 according to his or her own safety assessment:

Safety-irrelevant signal;
Safety-related signal;
Core safety signal.

Accordingly, the sensors generating these signals are classified into safety-irrelevant sensors 1, safety-related sensors 32 and core safety sensors 31.

In this case, the signal input into a safety-irrelevant sensor 1 can be, for example, a signal for controlling the conventional motion of an industrial robot. The signal input into a safety-related sensor 2 can be, for example, the braking state of a brake, error reporting monitoring signal of servo driver, ZSP monitoring signal, and key switch of the demonstrator. The signal input into a core safety sensor can usually include, for example, the signal of the enable switch of the demonstrator, emergency stop signal inside or outside the demonstrator or safety cage, and door switch signal of the safety cage. In an embodiment of the present application, a signal refers to information in any form and/or an input into a controller.

According to an embodiment of the present application, all core safety sensors 31, for example, emergency stop button, safety cage, interlocking gear and press switch, are directly connected to the main safety controller 7 and transmit core safety signals to the main safety controller 7. The main safety controller 7 can transmit these core safety signals to the auxiliary safety controller 52. The main safety controller 7 is also connected to various actuating devices of the safety actuating system 9 and controls the actions of the actuating devices of the safety actuating system 9 to realize safety operations.

Other safety-related signals, such as key switch of a robot and error reporting signal of servo driver, can be connected to the main safety controller 7 and/or the auxiliary safety controller 52 as required.

Safety-irrelevant signals are usually directly input into the robot controller 51, which is usually used to help execute motion instructions of the robot.

In the embodiment of the present application shown in FIG. 1, the safety control system 100 for an industrial robot comprises a main safety controller 7 and an auxiliary safety controller 52. The auxiliary safety controller 52 is a part of the robot controller 5. The main safety controller 7 and the auxiliary safety controller 52 communicate with each other through a digital I/O interface.

The main safety controller 7 is connected to the safety actuating system 9 for communication through a digital I/O interface. The safety actuating system 9 can comprise a servo driver 91, a main power supply 92 and a brake-holding power supply 93. As shown in FIG. 1, the main safety controller 7 can be connected to, communicate with and control all safety-related equipment, for example, servo driver 91, main power supply 92 and brake-holding power supply 93.

The auxiliary safety controller 52 is connected to and controls the equipment related to the safety-related functions and motion control functions in the safety actuating system. For example, the auxiliary safety controller communicates with and controls the servo driver 91 through a communication protocol (for example, PROFINET) or in another digital output mode.

The main safety controller 7 can receive core safety signals and/or safety-related signals according to the arrangement of the operator or designer. For all equipment 31 which can generate core safety signals, a pair of (namely, two) identical sensor elements are arranged at a point where core safety signals are generated to simultaneously generate two signals at the safety point and the pair of signals are transmitted to the main safety controller 7 through two channels. The main safety controller 7 analyzes the pair of core safety signals. When either of the pair of core safety signals indicates that the robot is in the normal working state, the main safety controller 7 will not send out any safety control signal.

According to an embodiment of the present application, all core safety actuators are equipped with two independent execution channels. For example, two AC contacts in series are provided for the safety torque off (STO) function, the main power supply off function and the power supply off function, while two contact relays are provided for the holding brake control function. However, the function of outputting safety-related signals and the motion control function are performed by the auxiliary safety controller 52 through a communication protocol, for example, PROFINET or in digital output mode.

The safety processes which the main safety controller 7 is responsible for should meet the requirements for PL=d or SIL2. The secondary safety processes which the auxiliary safety controller 52 is responsible for must not bring about any danger in an unconventional working mode of the robot system. For example, an action which the auxiliary safety controller 52 can take is to reduce the speed of the motor to zero before the main safety controller 7 brakes.

The following particularly describes the cooperation between the main safety controller 7 and the auxiliary safety controller 52.

For example, when a safety-related sensor 32 (for example, a sensor of a servo driver) sends out a driving error alarm signal, the signal is transmitted to the auxiliary safety controller 52 through a communication protocol or in another transmission mode. The auxiliary safety controller 52 generates a command according to the received safety-related signal and inputs it to the servo driver 91. This command instructs the servo driver to reduce the speed of the motor until the motor stops, for example.

On the other hand, the sensor of the servo driver can also send the driving error alarm signal to the main safety controller 7. The main safety controller 7 analyzes the alarm signal. If the alarm signal is determined to be a core safety signal, the main safety controller 7 sends a core safety instruction to the corresponding safety actuator, namely, servo driver 91 so that the servo driver 91 stops immediately, for example. If the alarm signal is determined to be a non-core safety signal, for example, a safety-related signal, the main safety controller 7 sends an instruction to the auxiliary safety controller 52, then the auxiliary safety controller 52 generates a command according to the received signal and inputs it into the servo driver 91. The command instructs the servo driver to reduce the speed of the motor until the motor stops, for example.

For example, when a component assigned as a core safety sensor 31 (for example, safety door switch) sends a door switch ON signal to the main safety controller 7, the main safety controller can directly send a shutdown instruction to an actuating device, for example, servo driver.

It should be understood that although the Description gives a description by embodiment, it does not mean that each embodiment contains only one independent technical solution. The description method in the Description is only for the sake of clarity. Those skilled in the art should consider the Description as an integral body. The technical solutions in all these embodiments can be combined properly to form other embodiments that those skilled in the art can understand.

The embodiments described previously are used only for illustrative purposes, but are not used to limit the scope of the present application. All equivalent variations, modifications, or combinations made by any of those skilled in the art without departing from the conception and principle of the present application should fall within the scope of protection of the present application.

The patent claims of the application are formulation proposals without prejudice for obtaining more extensive patent protection. The applicant reserves the right to claim even further combinations of features previously disclosed only in the description and/or drawings.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A safety control system for an industrial robot, comprising:
a first safety controller, connected to at least one core safety sensor configured to output a core safety signal, to receive the core safety signal when output; and
a second safety controller, connected to at least one safety-related sensor configured to output a safety-related signal, to receive the safety-related signal, wherein the first safety controller and the second safety controller are respectively connected to a safety actuating system.

2. The safety control system for an industrial robot of claim 1, wherein the first safety controller is a safety relay.

3. The safety control system for an industrial robot of claim 1, wherein each of the at least one core safety sensors comprises two identical sensor elements and is connected to the first safety controller through two channels.

4. The safety control system for an industrial robot of claim 1, wherein the first safety controller is connected to the at least one the safety-related sensor and is configured to receive the safety-related signal.

5. The safety control system for an industrial robot of claim 4, wherein the first safety controller is configured to communicate with the second safety controller.

6. The safety control system for an industrial robot of claim 1, wherein the safety actuating system comprises a first safety actuating device, and wherein the first safety controller and the second safety controller are respectively connected to the first safety actuating device for communication.

7. The safety control system for an industrial robot of claim 6, wherein the safety actuating system comprises at least one of a second safety actuating device and a third safety actuating device, and wherein the first safety controller is connected to at least one of the second safety actuating device and the third safety actuating device for communication.

8. The safety control system for an industrial robot of claim 1, wherein the second safety controller is a part of a robot controller.

9. A robot system, comprising the safety control system of claim 1.

10. The safety control system for an industrial robot of claim 2, wherein each of the at least one core safety sensors comprises two identical sensor elements and is connected to the first safety controller through two channels.

11. The safety control system for an industrial robot of claim 2, wherein the first safety controller is connected to the at least one the safety-related sensor and is configured to receive the safety-related signal.

12. The safety control system for an industrial robot of claim 11, wherein the first safety controller is configured to communicate with the second safety controller.

13. The safety control system for an industrial robot of claim 2, wherein the safety actuating system comprises a first safety actuating device, and wherein the first safety controller and the second safety controller are respectively connected to the first safety actuating device for communication.

14. The safety control system for an industrial robot of claim 13, wherein the safety actuating system comprises at least one of a second safety actuating device and a third safety actuating device, and wherein the first safety controller is connected to at least one of the second safety actuating device and the third safety actuating device for communication.

15. A robot system, comprising the safety control system of claim 2.

16. A robot system, comprising the safety control system of claim 3.

17. A robot system, comprising the safety control system of claim 6.
